(19) United States
(12) Patent Application Publication
(10) Pub. No.: US 2025/0019231 A1
(43) Pub. Date: Jan. 16, 2025

(54) METHOD FOR STORING HYDROGEN IN A METALLIC BASE MATERIAL BY MEANS OF A DIRECT HYDROGEN ENRICHMENT, AND HYDROGEN-CONTAINING MATERIAL WHICH CAN BE OBTAINED THEREBY AND USE THEREOF

(71) Applicants: Dan DRAGULIN, Calw (DE); Heinrich GÖDECKE, Elze (DE); Jochen HOLDER, Bissingen (DE); Karsten SEEHAFER, Hannover (DE)

(72) Inventor: Dan DRAGULIN, Calw (DE)

(21) Appl. No.: 18/701,605

(22) PCT Filed: Aug. 3, 2022
(86) PCT No.: PCT/EP2022/000072

§ 371 Date: Apr. 15, 2024

(30) Foreign Application Priority Data
Oct. 16, 2021 (DE) 10 2021 005 181.5

(51) Int. Cl. C01B 3/00; C22C 21/06; C22C 23/02

(52) U.S. Cl. CPC C01B 3/0031; C22C 21/06; C22C 23/02

(57) ABSTRACT

A method for storing hydrogen in a metallic base material is disclosed along with material which can be obtained according to the method, and to the use of said material for providing hydrogen by releasing the hydrogen from the material. The method prevents disadvantages of conventional methods for storing H₂. This is achieved in that hydrogen is stored by means of direct hydrogen enrichment of a metallic base material provided in the liquid or gaseous state and subsequent rapid solidification. An Al—Mg alloy or Al or Mg is used as the metallic base material. The material enriched with hydrogen contains hydrogen in the form of metal hydrides as well as in the dissolved form and as pores.

The invention relates to a method for storing hydrogen in a metallic base material by direct hydrogen enrichment of the base material, which is present in liquid or gaseous state, and subsequent rapid solidification. The metallic base material used is an Al—Mg alloy or Al or Mg.

The invention further relates to the hydrogen-containing material obtainable by the method according to the invention, said material containing hydrogen in the form of metal hydrides.

The invention furthermore relates to the use of said hydrogen-containing material for the purpose of providing hydrogen by releasing the hydrogen from the material.

The use of so-called renewable energies such as wind and solar energy for power generation is known to have the disadvantage that these energies are not continuously available, which leads to fluctuations in power generation. As a result, there is a growing need for storage facilities so that energy can be stored during periods of high energy supply and fed back into the grid during periods of low energy supply or increased electricity consumption.

Since direct storage of electrical energy is technically hardly possible, it is necessary to convert this energy into another form of energy which can be stored temporarily for later conversion into electricity or for other utilization. With regard to energy industry, a well-known concept for storing electricity is based on the use of hydrogen as an energy carrier. Here, electricity supplied by renewable energy sources is used to produce hydrogen (usually by electrolysis of water), especially during temporary electricity surpluses.

The hydrogen produced in this way can be stored in suitable storage facilities for a short or longer period of time and then converted back into electricity (e. g., by means of fuel cells) or used in other ways (e. g. methanation, combustion).

Hydrogen can either be stored in gaseous form in pressurized storage tanks or, after low-temperature liquefaction, in suitable cryogenic containers. The disadvantages are the high weight of the storage tanks, the risk of hydrogen leaks and the energy required for cryogenic refrigeration. Due to these disadvantages, the above-mentioned hydrogen storage systems are uneconomical and are hardly suitable or unsuitable, above all, for mobile applications, for example in vehicles.

Furthermore, it is known to store hydrogen in the form of metal hydrides, which are present in solid form. Under the influence of heat, the chemically bound hydrogen can later be released from the metal hydrides.

The production of these metal hydrides is generally carried out in such a way that the respective metal, in the solid state, is brought into contact with hydrogen so that the latter can diffuse into the metal. As a result, a hydride layer forms on the metal surface. However, the growing hydride layer makes it more difficult for the hydrogen to diffuse into the interior of the metal.

It was therefore the object of the present invention to provide a method of manufacturing a hydrogen-containing storage material, and to provide a hydrogen-containing storage material, which avoids or alleviates the above-mentioned disadvantages, but in particular enables improved hydrogen enrichment in the form of metal hydrides.

According to the present invention, the object is achieved by a method according to the main claim and by a hydrogen-containing material according to claim 12, as well as by the embodiments indicated in the further claims and in the following description.

Accordingly, the method according to the invention is used for the storage of hydrogen in a metallic base material under formation of metal hydrides. The metallic base material used in the method is
(i) an Al—Mg alloy, or
(ii) aluminium, or
(iii) magnesium.

The method comprises the following steps:
(a) feeding H₂ into a melt of the base material to enrich the base material with H₂, the feeding of H₂ being carried out at a temperature which
   in the case of the use of an Al—Mg alloy, is at least as high as the solidus temperature of the Al—Mg alloy, or
   in the case of the use of an Al melt or Mg melt, is at least as high as the melting temperature of aluminium or of magnesium;
b) rapid, preferably ultra-rapid, cooling of the melt in order to solidify the melt.

As indicated, an Al—Mg alloy or aluminium or magnesium is used as the metallic base material. The base material can, in addition to the elements (Al, Mg) mentioned, contain common or unavoidable admixtures (accompanying elements), the proportion of such admixtures preferably being limited to a maximum of 5% by weight in total, in particular to a maximum of 2% by weight, in each case relative to the base material as a whole. Examples of such admixtures are Fe, Cu, Zn, Mn. The base material thus consists of Al and Mg, or of Al or Mg, in each case with usual or unavoidable admixtures. Preferably, Al and/or Mg with a purity of at least 99% by weight is used for the production of the base material.

In the case of using an Al—Mg alloy, the Al/Mg ratio can be varied as desired. In particular, the Al/Mg ratio (based on the proportions in % by weight) comprises all combinations between 99.99% Al at 0.01% Mg and 0.01% Al at 99.99% Mg, preferably all combinations between 99% Al at 1% Mg and 1% Al at 99% Mg, more preferably all combinations between 95% Al at 5% Mg and 5% Al at 95% Mg.

Accordingly, an alloy having an Al excess can be used as an Al—Mg alloy. Preferably, the Al content of such an alloy is at least 55% by weight, in particular at least 65% by weight, in each case based on the total content of Al and Mg.

An alloy having an excess of Mg can also be used as an Al—Mg alloy. Preferably, the Mg content of such an alloy is at least 55% by weight, in particular at least 65% by weight, in each case based on the total content of Al and Mg.

In order to produce the melt of the base material, in principle all installations and processes known to the skilled person for melting metals can be used, for example electric melting furnaces (e. g. induction furnaces, arc furnaces) or melting furnaces heated with fuels (e. g. coke-, graphite-, oil- or gas-fired furnaces). Preferably, a plasma reactor (plasma melting furnace) is used for carrying out the melting process and preferably also for the subsequent hydrogen enrichment. The way in which the plasma is generated is not important for carrying out the method according to the invention.

In the most preferred embodiment of the method according to the present invention, the enrichment of the melt with hydrogen (supply of H₂) in step (a) of the method takes place under the action of plasma, in particular by using a plasma reactor. The optionally preceding generation of the melt of the metallic base material can likewise be effected by means of plasma, or by means of the already mentioned melting furnaces (induction furnaces, furnaces heated with fuels, etc.).

When carrying out the hydrogen enrichment of the molten metal using a plasma, the influence of the plasma can lead to the formation of atomic hydrogen. The hydrogen present in the atomic state also participates in the process of enrichment.

In order to enrich the base material with hydrogen according to the principle of direct hydrogen enrichment, hydrogen is fed to the melt, as indicated in step a) of the method. This results in the formation of Al—Mg hydrides, Al hydrides and/or Mg hydrides.

For enriching the melt with hydrogen, hydrogen-containing gas mixtures can be used in addition to hydrogen, said mixtures containing hydrogen, for example, in combination with argon, nitrogen, neon, xenon, radon or chlorine. The hydrogen used is preferably hydrogen obtained by using regenerative energies (e. g., by hydrolysis plants operated with wind or solar energy). However, there is no restriction as to the origin of the hydrogen used in the process; for example, hydrogen resulting from or obtained in chemical processes (e. g. hydrogen from synthesis gas) can also be used.

When an Al—Mg alloy is used as the base material, hydrogen is supplied at a temperature which is at least as high as the solidus temperature of the Al—Mg alloy. This ensures that during hydrogen supply the Al—Mg alloy is essentially in the molten state or preferably completely molten. Enrichment of the Al—Mg alloy with hydrogen is preferably carried out at a temperature at which the base material (Al—Mg alloy) is completely in the liquid state (i. e. at or above the liquidus temperature). The hydrogen supply can also be carried out at a temperature that lies between the solidus and the liquidus temperature of the respective Al—Mg alloy. Under these temperature conditions, the base material (Al—Mg alloy) is partly in dissolved state and partly in solid state.

When using aluminium or magnesium as the base material, the hydrogen supply takes place at a temperature which is at least as high as the melting temperature of aluminium or magnesium. This ensures that the aluminium or magnesium is essentially in a molten state or preferably completely molten during hydrogen supply. The enrichment of Al or Mg with hydrogen is preferably carried out at a temperature at which the base material (Al or Mg) is completely in the liquid state.

According to a further embodiment of the method according to the invention, the H₂ supply in step a) is carried out at a temperature which is above the boiling temperature of the base material (Al—Mg alloy or Al or Mg). In this case, the base material is at least partially in the form of a vapour (metal vapour) during the hydrogen supply. The temperature can also be selected so that the base material is completely in the form of a metal vapour during the hydrogen feed. If the process temperature during the H₂ supply—as indicated—is above the boiling temperature of the respective base material, the reaction of Al and/or Mg with H₂ (with formation of the respective metal hydrides) takes place in the gas or vapour phase.

In general, the enrichment of the base material with hydrogen takes place in the same space or container in which the base material is melted. Alternatively, the previously produced melt can be conveyed or transported to another space or container for the purpose of hydrogen enrichment. The production of the melt can take place independently of the implementation of the hydrogen supply. In any case, the space or container in which the melt of the base material is located during hydrogen supply (for hydrogen enrichment of the base material) is hereinafter referred to as the “melt container”.

The walls of the melt container are expediently made of materials which withstand the temperatures occurring during the process and are suitable for the metal melts used in the method according to the invention, and which are substantially impermeable to hydrogen. Materials suitable for this purpose are known to the skilled person.

The supply of hydrogen for the purpose of enriching the metallic base material with hydrogen (step a) of the method) can generally be effected by introducing hydrogen into the melt container so that hydrogen flows through the melt in the melt container. In principle, hydrogen can be fed from all directions and in all directions, for example vertically (in the perpendicular direction) from the top to the bottom or from the bottom to the top, or from one side wall or two or more side walls of the melt container; different combinations of the aforementioned variants are also possible.

Hydrogen is generally supplied by means of one, two or preferably more inlet openings arranged in a wall of the melt container. The inlet opening(s) may also be arranged in two or more walls of the melt container. The inlet openings may be connected to a hydrogen storage tank or a hydrolyser via feed lines. Furthermore, pumps, valves and other devices known to the person skilled in the art may be provided in order to be able to control or regulate the pressure or/and the volume flow (volumetric flow rate) when feeding the hydrogen into the melt container.

In order to enhance the flow of hydrogen through the melt or in order to influence the direction of flow, one, two or preferably more outlet openings for the hydrogen can be provided on at least one wall of the melt container. It is expedient that these outlet openings are arranged in such a way that an undesired leakage of the molten metal is avoided. It is further preferred that the excess hydrogen (“residual hydrogen”) escaping via the outlet openings is collected and returned via corresponding pipelines.

According to one embodiment of the method according to the invention, a melt container (i.e., the space in which the melt is located) is used which can be sealed tightly (i.e., hydrogen-tight). H₂ is supplied (step a) at a temperature high enough for the base material to be completely in the liquid state (melt). The hydrogen is introduced into the space (and thus into the melt) under pressure, while the melt container is closed so as to be hydrogen-proof. Since the hydrogen solubility in the melt increases with higher temperature and increasing pressure, the hydrogen enrichment of the base material (Al—Mg alloy, or Al or Mg) can be increased by increasing the temperature of the melt or/and the pressure in the melt container. Preferably, the melt is subjected to an overpressure during the H₂ supply. The overpressure (relative to the ambient pressure) is preferably 100 Pa or higher, in particular 1 kPa or higher; even higher pressures can be considered.

According to a further embodiment of the method according to the invention, a melt container is used which allows the free escape (e. g., by means of outlet openings as mentioned above) of that part of the hydrogen which does not remain bound in the melt. The H₂ supply (step a) takes place at a temperature which is so high that the base material is completely in the liquid state (melt).

According to a further embodiment of the method according to the invention, a melt container is used which is equipped with devices (e. g. pipes, pumps, valves) which enable a closed circulation of the hydrogen, so that that part of the hydrogen which is not absorbed by the melt is returned to the melt container, optionally with addition of fresh H₂. In this way, the melt is subjected to a constant supply of hydrogen (recycled hydrogen portion together with admixture of “fresh” hydrogen). In this process variant, too, the H₂ supply (step a) takes place at a temperature that is high enough for the base material to be completely in the liquid state (melt).

In the method according to the invention described above in general terms, as well as in the embodiments or method variants described above, the following modifications, among others, are possible:
The melt container can additionally be filled or flowed through with a protective gas or a protective gas mixture during the hydrogen supply into the melt. Inert gases such as nitrogen or noble gases (especially argon) can be used as inert gases.
A vacuum may be present in the melt container during the supply of hydrogen to the melt (i. e. a pressure lower than atmospheric pressure is set), or the pressure in the melt container corresponds to the atmospheric pressure, or the pressure prevailing in the melt container is higher than the atmospheric pressure (overpressure).
A melting furnace or melting reactor can be used as the melt container in which the melt of the base material is located and in which the enrichment of the base material with hydrogen takes place.
The production of the melt of the base material and the tempering of the melt during the hydrogen enrichment can be carried out in a manner known per se by heat conduction, convection or heat radiation.
For the melting process (melting of the metallic base material) as well as for subsequent hydrogen enrichment, a plasma furnace (plasma melting furnace) or plasma reactor is preferably used.
“Surplus” regenerative energy (surplus electricity) can be used to generate the melt (by means of melting furnaces, plasma reactors, etc.) and to heat the base material during hydrogen supply, as well as for a preceding hydrogen production by electrolysis.

According to claim 1 (step b), a further essential feature of the method according to the invention is that the melt of the base material is subjected to rapid cooling after enrichment with hydrogen (step a) in order to bring about solidification of the melt.

“Rapid cooling” is understood to mean cooling with a cooling rate of at least 500 K/s (=500° C./s), in particular of at least 1,000 K/s. Preferably, the melt is subjected to ultra-rapid cooling, the cooling rate being at least 10,000 K/s, preferably at least 100,000 K/s.

By rapid cooling, in particular by ultra-rapid cooling, a higher enrichment of the base material with hydrogen can be achieved compared to the hydrogen content that would result without said cooling measures as a result of equilibration with the surrounding atmosphere. By the rapid, preferably ultra-rapid cooling, the hydrogen content of the base material produced by the hydrogen enrichment can be kept constant and a possible loss of hydrogen to the environment can be prevented or at least reduced. In particular, the rapid, preferably ultra-rapid cooling additionally causes gaseous hydrogen to be enclosed in cavities (bubbles, pores, etc.) of the solidifying melt. With the method according to the invention, a total hydrogen content (in the form of hydrides, pores and dissolved H₂) of 0.02 cm³/100 g can be achieved (based on room temperature, i. e. 20° C.).

In a preferred embodiment of the method according to the invention, ultra-rapid cooling of the melt is effected by applying the melt enriched with hydrogen in step a) to a rotating body, preferably a wheel, a roller or a disc, made of a material with high thermal conductivity, the rotating body preferably being cooled during this process. Alternatively or additionally, a cooling fluid (cooling liquid or gases) can be applied to the rotating body from the outside.

The melt impinging against the rotating body solidifies as a result of the rapid or ultra-rapid cooling and the solidified melt is generally flung away from the rotating body in particulate form under the effect of centrifugal force. The product that can be obtained in this way is a hydrogen-enriched base material in particulate form.

“High thermal conductivity” is understood to mean, in particular, a thermal conductivity of 100 W/m·s or higher, preferably of 200 W/m·s or higher. In particular, copper is suitable as a material with high thermal conductivity.

The application of the hydrogen-enriched melt to the rotating body can be effected, for example, by the melt flowing out through one, two or more openings of the melt container and the outflowing melt impinging on the rotating body, for example via a channel. Another possibility is that the melt is taken from the melt container via one, two or more pipes and the liquid jet is applied to the rotating body via one, two or more nozzles, preferably under pressure.

To enable the process to be carried out more efficiently, it can be advantageous if two or more rotating bodies are associated with each melt container and are operated simultaneously.

In order to obtain the smallest possible particle size of the solidified material, the rotating body is preferably operated at high rotational speeds. Preferably, the rotational speed is adjusted so that the tangential speed achieved thereby is greater than 10 m/s, preferably greater than 20 m/s.

The mentioned rotating body usually has the shape of a wheel, a roll or a drum, each with a circular cross-section, whereby the rotation takes place around the respective axis. The outer diameter of these bodies can be, for example, 0.5 to 2 m, the length (in axial direction) can be, for example, 0.1 m to 5 m. For the purpose of weight reduction and to enable cooling from the inside, the rotating bodies used are preferably hollow on the inside (e. g. drum) or equipped with cavities.

The cooling rate can alternatively or additionally be increased by cooling the rotating body (from the inside or on the surface, for example with water), and/or by cooling the melt coming from the melt container before and during the impact against the rotating body, preferably by means of a cooling fluid (e. g. cooled inert gas). For this purpose, it is advantageous if the ambient temperature in the ambiance of the rotating body is kept as low as possible, for example by flowing a cooling fluid (e. g. inert gas, air, water) around the rotating body.

According to a further method, the aforementioned rapid, in particular ultra-rapid, cooling of the melt is effected by using a cooling fluid. Gases or gas mixtures (e. g. inert gases or air) or liquids (e. g. water, liquid gases) can be used as cooling fluids. For example, the hydrogen-enriched melt may be sprayed into a cooling fluid or injected into the cooling fluid by means of a nozzle, whereby the melt droplets produced thereby solidify into melt particles.

The cooling of the melt mentioned in claim 1 (step b) can be carried out in a normal air atmosphere.

According to a preferred embodiment, however, this process step is carried out in an atmosphere which causes stabilisation of the Al—Mg hydrides (or Al hydrides, Mg hydrides), in particular by forming an aluminium oxide layer or aluminium hydroxide layer on the surface of the solidified hydrogen-containing base material. In a similar way, corresponding magnesium oxide layers and magnesium hydroxide layers can also be formed as stabilising surface layers.

In general, stabilisation of the hydrogen-containing material is effected by bringing the material into contact, during the cooling process, with one or more media which are suitable for the formation of protective layers (e. g. Al—Mg oxides or Al—Mg hydroxides). Suitable media for the formation of protective layers are, for example, air, water, toluene, benzene, diphenyl acetylene (=dyphenyl-ethyne) or nitrocellulose. Combinations of two or more such media can also be used, e. g. humid air (air-water mixture).

The method according to the invention can be carried out both in batch operation (discontinuous) and continuously.

The method according to the invention—as indicated in the patent claims and as described above—provides a hydrogen-containing material which contains hydrogen in the form of metal hydrides, in particular in the form of Al hydrides, Mg hydrides and Al—Mg hydrides.

The method is thus not only used for storing hydrogen in the metallic base material mentioned but can also be used in general for producing Al hydrides, Mg hydrides and Al—Mg hydrides.

The invention thus also extends to a hydrogen-containing material obtained by carrying out the method according to the invention or obtainable by such a method, wherein the hydrogen-containing material contains hydrogen in the form of Al hydrides, Mg hydrides and Al—Mg hydrides.

Said hydrides could be stoichiometrically or non-stoichiometrically composed. The hydrides include ternary hydrides having the formula AlₓMg_{y}H_{z} as well as binary hydrides with the formula AlₓH_{z} or Mg_{y}H_{z}, where the indices can be integers, rational numbers (especially fractions) or real or complex numbers. The types of metal hydrides formed in the process depend on the composition of the base material. If an Al—Mg alloy is used as the base material, AlₓMg_{y}H_{z}, AlₓH_{z} and Mg_{y}H_{z} are formed, and if Al or Mg is used as the base material, the corresponding binary hydrides (AlₓH_{z} or Mg_{y}H_{z}) are formed.

Due to the method according to the invention, the hydrogen-containing material thus produced contains hydrogen not only in chemically bound form (as hydrides), but also as gaseous hydrogen, which due to the aforementioned rapid or ultra-rapid cooling of the melt remains enclosed in the solidified base material, in particular in the form of cavities (such as bubbles or pores) embedded in the material.

Furthermore, due to the aforementioned rapid or ultra-rapid cooling of the hydrogen-enriched melt, the hydrogen-containing material also contains a proportion of dissolved hydrogen that is dissolved in the base material. In the context of the present invention, the term “hydrogen-containing” thus refers not only to chemically bound hydrogen in the form of the aforementioned metal hydrides, but also includes the case where hydrogen is contained in the hydrogen-containing material as gaseous hydrogen and/or in dissolved form.

Due to the storage of hydrogen in at least three different forms (as hydrides; gaseous; dissolved in the metal), the hydrogen-containing material according to the invention is advantageously suitable for a wide range of applications.

The invention therefore further extends to the use of a hydrogen-containing material, which is produced or obtainable by the method according to the invention, for providing hydrogen by releasing hydrogen (e.g., by the action of heat) from the hydrogen-containing material. This can be done either in stationary systems or in mobile systems (e.g. vehicles), in particular in combination with fuel cells.

The release of hydrogen from the hydrogen-containing material can be effected in particular by the effect of temperature (100° C. or higher), or under the influence of an electromagnetic field or by the effect of certain media which are suitable for the release of hydrogen from metal hydrides. The aforementioned methods for releasing hydrogen can also be used in any combination.

The release of hydrogen in the case of AlH₃ can be described by the generic formula AlH₃→Al+1.5 H₂. As an example of media that are suitable for the release of hydrogen from metal hydrides, H₂O should be mentioned in particular. In this case, the release of H₂ can be described by the following reaction equation:

AlH₃+3 H₂O→Al(OH)₃+3 H₂.

After the release of hydrogen, the metallic base material can preferably be used again in a process for storing hydrogen as described above.

The hydrogen-containing material, in particular the metal hydrides produced by the method according to the invention, can be used for a variety of applications, for example for batteries or accumulators (lithium-free), for fuel cells (with Al—Mg hydrides), and as a fuel, motor fuel or combustible (e. g., for rockets, torpedoes, heating devices, heating systems).

### DESCRIPTION OF THE DRAWINGS

Some aspects of the method according to the invention are explained in more detail with reference to the drawings FIG. 1 and FIG. 2. These are merely exemplary embodiments.

FIG. 1 illustrates in a schematic, not true-to-scale representation a possible method for direct hydrogen enrichment of the base material (corresponding to step (a) of the method according to claim 1).

The arrows (a) indicate the hydrogen supply through supply openings (not shown) in the wall (2) of a melt container (1). The hydrogen can be supplied from below, from the side and/or from above, as shown.

The hydrogen supplied flows through the melt (4) of the base material present inside the melt container (1), which is thereby enriched with hydrogen. The excess hydrogen, which does not remain in the base material, can escape from the melt container (1) in an upward direction via several openings (3), as indicated by the arrows (b).

FIG. 2 illustrates in a schematic, not-true-to-scale representation a possible (and preferred) method to effect an ultra-fast cooling of the melt for the purpose of solidification of the melt (corresponding to step (b) of the method according to claim 1).

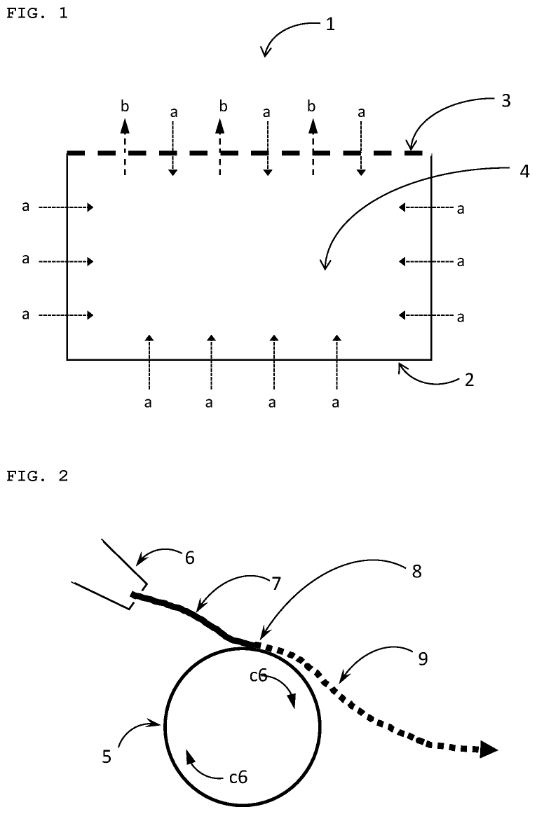

In this case, the hydrogen-enriched melt (7) coming from a melt container (not shown in FIG. 2) is applied by means of a nozzle (6) or another application device to a rapidly rotating wheel or drum (5) made of a material with high thermal conductivity (here: copper) in a continuous jet. The direction of rotation of the wheel or drum (5) is shown by the arrows (c).

As soon as the melt (7) hits the surface (jacket surface) of the rotating wheel or drum (5) (approximately at the point indicated by arrow (8)), an ultra-rapid solidification of the melt occurs, and the solidified hydrogen-containing material (9) is flung away from the rotating wheel or drum (5) by centrifugal force.

The solidified hydrogen-containing material can then be collected in suitable containers and, where appropriate, supplied to storage or further treatment.

### LIST OF REFERENCE SIGNS

1) Melt container
2) Wall of the melt container
3) Openings (in the wall of the melt container)
4) Melt in the melt container
5) Rotating wheel or rotating drum
6) Nozzle
7) Melt (coming out of the nozzle)
8) Point of the wheel (5) or drum (5) where the melt hits
9) Solidified melt (metallic material containing H₂)
a) Hydrogen is fed into the melt container
b) Hydrogen escaping from the melt container
c) Direction of rotation of the wheel (5) or drum (5).

1-16. (canceled)

17. A method for storing hydrogen in a metallic base material with formation of metal hydrides,
wherein said metallic base material is
(i) an Al—Mg alloy, or
(ii) aluminium, or
(iii) magnesium,
and wherein the method comprises the following steps:
a) feeding H₂ into a melt of the base material to enrich the base material with H₂, wherein during the enrichment the melt is in a space or container, referred to as “melt container” in the following, and the enrichment of the melt with H₂ is effected by feeding H₂ into the melt container so that the melt contained therein is flowed through with H₂, and wherein the feeding of H₂ is carried out at a temperature which
in the case of the use of an Al—Mg alloy
is at least as high as the solidus temperature of the Al—Mg alloy, or
in the case of the use of an Al-melt or Mg-melt
is at least as high as the melting temperature of aluminium or of magnesium;
b) rapid cooling of the melt at a cooling rate of at least 500 K/s, for the purpose of solidification of the melt.

18. The method according to claim 17, wherein, when an Al—Mg alloy is used as the base material, the Al/Mg ratio, based on the proportions of Al and Mg in % by weight, comprises all combinations between 99.99% Al at 0.01% Mg and 0.01% Al at 99.99% Mg, preferably all combinations between 99% Al at 1% Mg and 1% Al at 99% Mg.

19. The method according to claim 17, wherein in method step b) an ultra-rapid cooling of the melt is effected, the cooling rate being at least 10,000 K/s, preferably at least 100,000 K/s.

20. The method according to claim 19, wherein the ultra-rapid cooling of the melt is effected by applying the melt which has been enriched with hydrogen in step a) to a rotating body, preferably a wheel, a roll or a disk, made of a material with high thermal conductivity, the rotating body preferably being cooled during this process.

21. The method according to claim 19, wherein the ultra-rapid cooling of the melt is effected by means of a cooling fluid, preferably by spraying or injecting the H₂-enriched melt into the cooling fluid.

22. Method according to claim 17, wherein in step a) the H₂ supply takes place at a temperature which is above the boiling temperature of the base material.

23. Method according to claim 17, wherein the temperature during the supply of H₂ (step a) is so high that the base material is completely in the liquid state (melt), and that the space in which the melt is located (=melt container) can be tightly closed, and wherein hydrogen is introduced into the space under pressure.

24. Method according to claim 17, wherein the temperature during the supply of H₂ (step a) is so high that the base material is completely in the liquid state (melt), and in that the melt container allows the escape of that portion of the hydrogen which is not absorbed by the melt.

25. Method according to claim 17, wherein the temperature during the supply of H₂ (step a) is so high that the base material is completely in the liquid state (melt), and that the melt container is equipped with means which enable a closed circulation of the hydrogen, so that that portion of the hydrogen which is not absorbed by the melt is returned to the melt container, optionally with admixture of fresh H₂.

26. Method according to claim 17, wherein in step a) hydrogen is supplied in the form of a hydrogen-containing gas mixture, the gas mixture preferably containing one or more gases from the group comprising nitrogen, argon, neon, xenon, radon and chlorine.

27. Method according to claim 17, wherein the enrichment of the melt with hydrogen takes place under the action of a plasma.

28. Method according to claim 17, wherein the melt of the base material is produced by means of a plasma reactor, it being preferred that the enrichment of the melt with hydrogen is likewise carried out in a plasma reactor.

29. A method of using a hydrogen-containing material, obtained by or obtainable by a method according to claim 17, the method including providing hydrogen by releasing hydrogen from said material, and wherein the metallic base material after the release of the hydrogen is preferably re-used for storing hydrogen.
